(19) United States
(12) Patent Application Publication
(10) Pub. No.: US 2010/0260291 A1
(43) Pub. Date: Oct. 14, 2010

(54) Carrier Recovery Device and Related Method

(76) Inventors: Wen-Sheng Hou, Hsinchu County (TW); You-Duan Chen, Hsinchu County (TW); Wen-Tong Kuo, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/564,919

(22) Filed: Sep. 23, 2009

(30) Foreign Application Priority Data
Apr. 10, 2009 (TW) 098112027

(51) Int. Cl. H04L 27/06; H04L 25/06; H04L 27/22

(52) U.S. Cl. 375/319; 375/344; 375/329

(57) ABSTRACT

A carrier recovery device for a communication receiver is disclosed. The carrier recovery device includes an A/D converter for converting an analog signal received by the communication receiver to a digital signal, a frequency compensator coupled to the A/D converter for compensating frequency of the digital signal according to a carrier frequency offset value, a filter coupled to the frequency compensator for filtering the digital signal to generate an output signal, and a frequency offset estimator coupled to the filter and the frequency compensator for estimating the carrier frequency offset value according to the output signal and providing the carrier frequency offset value to the frequency compensator for implementing carrier recovery.

### BACKGROUND OF THE INVENTION

1. Field of the Invention

The present invention relates to a carrier recovery device and related method, and more particularly, to a carrier recovery device and related method capable of compensating carrier frequency offset accurately.

2. Description of the Prior Art

Bluetooth is a short distance wireless technology which serves as a bridge among dissimilar devices for establishing a wireless connection to transmit data and voice. Also, Bluetooth has several advantages, including low-power, low-cost, small size, light weight, and is used more and more frequently in daily life.

Please refer to FIG. 1, which is a schematic diagram of a conventional common Bluetooth packet format 10. As shown in FIG. 1, the common Bluetooth packet format 10 includes an access code 102, a header 104, and a data packet 106. The access code 102 is utilized for identifying packet. The header 104 is used for illustrating type and length of data. The data packet 106 is the transmitted data and/or voice content. In early versions of the Bluetooth specification, transmission of Bluetooth uses the Gaussian Frequency Shift Keying (GFSK) modulation technique. In version 2.0+ of the Bluetooth specification with Enhanced Data Rate (EDR), the access code 102 and the header 104 use the GFSK modulation technique, and the data packet 106 uses the Differential Phase Shift Keying (DPSK) modulation technique.

However, in wireless communication systems, carrier frequency offset occurs due to frequency mismatch between the local oscillators at the transmitter and the receiver, and thus reduces transmission performance. In such a situation, the original signal will be recovered by the receiver inaccurately. Therefore, a carrier recovery method is needed for recovering the transmitted signal exactly.

### SUMMARY OF THE INVENTION

It is therefore a primary objective of the present invention to provide a carrier recovery device and related method.

The present invention discloses a carrier recovery device for a communication receiver, comprising an A/D converter for converting a received analog signal to a digital signal; a frequency compensator coupled to the A/D converter for compensating frequency of the digital signal according to a carrier frequency offset value; a filter coupled to the frequency compensator for filtering the digital signal to generate an output signal; and a frequency offset estimator coupled to the filter and the frequency compensator for estimating the carrier frequency offset value according to the output signal and providing the carrier frequency offset value to the frequency compensator for implementing carrier recovery.

The present invention further discloses a carrier recovery method for a communication receiver, comprising converting a received analog signal to a digital signal; filtering the digital signal to generate an output signal; estimating a carrier frequency offset value of the output signal; and compensating frequency of the digital signal according to the carrier frequency offset value for implementing carrier recovery.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional common Bluetooth packet format.

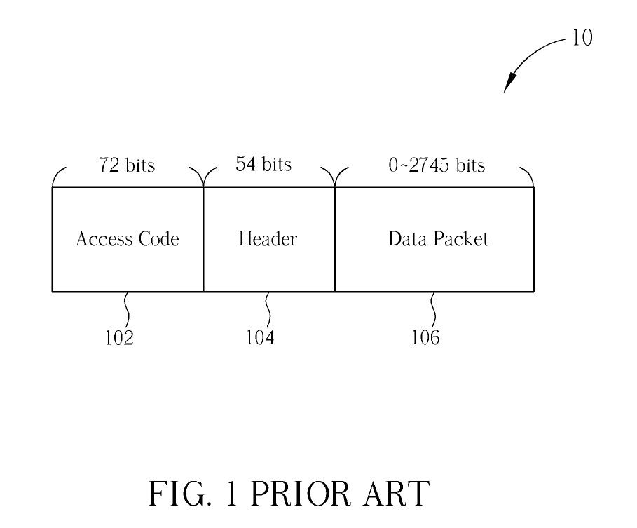

FIG. 2 is a schematic diagram of a carrier recovery device according to an embodiment of the present invention.

FIG. 3 is a schematic diagram of the frequency offset estimator shown in FIG. 2 according to an embodiment of the present invention.

FIG. 4 is a schematic diagram of the frequency offset estimator shown in FIG. 2 according to another embodiment of the present invention.

FIG. 5 is a schematic diagram of the frequency offset estimator shown in FIG. 2 according to another embodiment of the present invention.

FIG. 6 is a procedure according to an embodiment of the invention.

### DETAILED DESCRIPTION

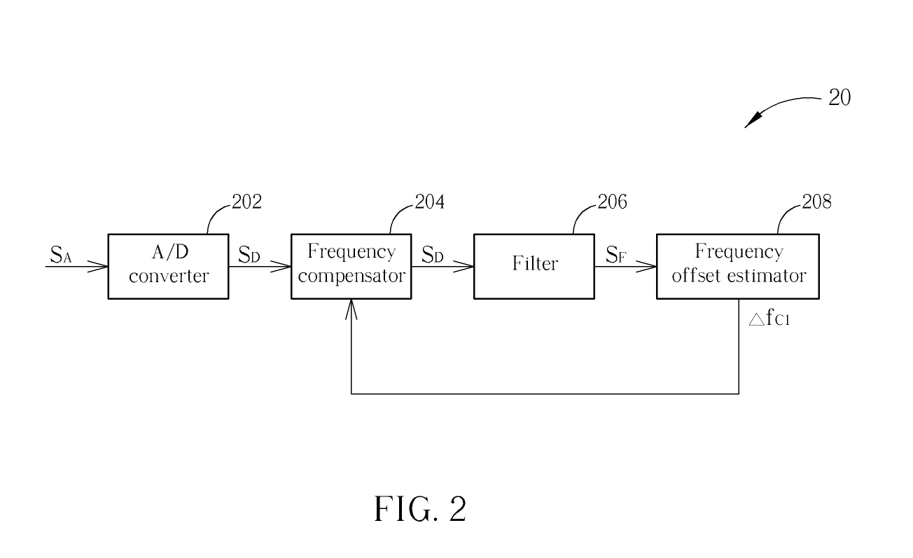

Please refer to FIG. 2, which is a schematic diagram of a carrier recovery device 20 according to an embodiment of the present invention. The carrier recovery device 20 is utilized for a wireless communication receiver. In the embodiment, the wireless communication receiver is preferably a Bluetooth receiver, but this should not be a limitation of the present invention. The carrier recovery device 20 is capable of modifying offset carrier frequency according to the signal received by the wireless communication receiver to provide a correct carrier to the wireless communication receiver for recovering the received signal. Furthermore, the carrier recovery device 20 includes an analog to digital (A/D) converter 202, a frequency compensator 204, a filter 206, and a frequency offset estimator 208. The A/D converter 202 is utilized for converting an analog signal S_{A} received by a Bluetooth communication receiver to a digital signal S_{D}. In other words, the embodiment of the present invention transforms the received signal by A/D converter in order to modify the carrier frequency through a digital signal process. The frequency compensator 204 is coupled to the A/D converter 202 for compensating frequency of the digital signal S_{D} according to a carrier frequency offset value Δf_{C}. The filter 206 is coupled to the frequency compensator 204 for filtering the digital signal S_{D} to generate an output signal S_{F}. The frequency offset estimator 208 is coupled to the filter 206 and the frequency compensator 204 for estimating the carrier frequency offset value Δf_{C} according to the output signal S_{F} and providing the carrier frequency offset value Δf_{C} to the frequency compensator 204 for implementing carrier recovery. Therefore, the frequency offset estimator 208 is capable of replying the estimated carrier frequency offset value Δf_{C} to the frequency compensator 204 for implementing a frequency compensation process with the digital signal S_{D}, and adjusting the most accuracy carrier frequency for recovering the received signal after repeating the above-mentioned process.

In brief, the present invention can estimate the carrier frequency offset value Δf_{C} through a digital signal process for compensating frequency of the digital signal S_{D} to recover the received signal accurately. As a result, the present application can keep the received signal from being destroyed by the filter, improve signal distortion, and enhance system performance.

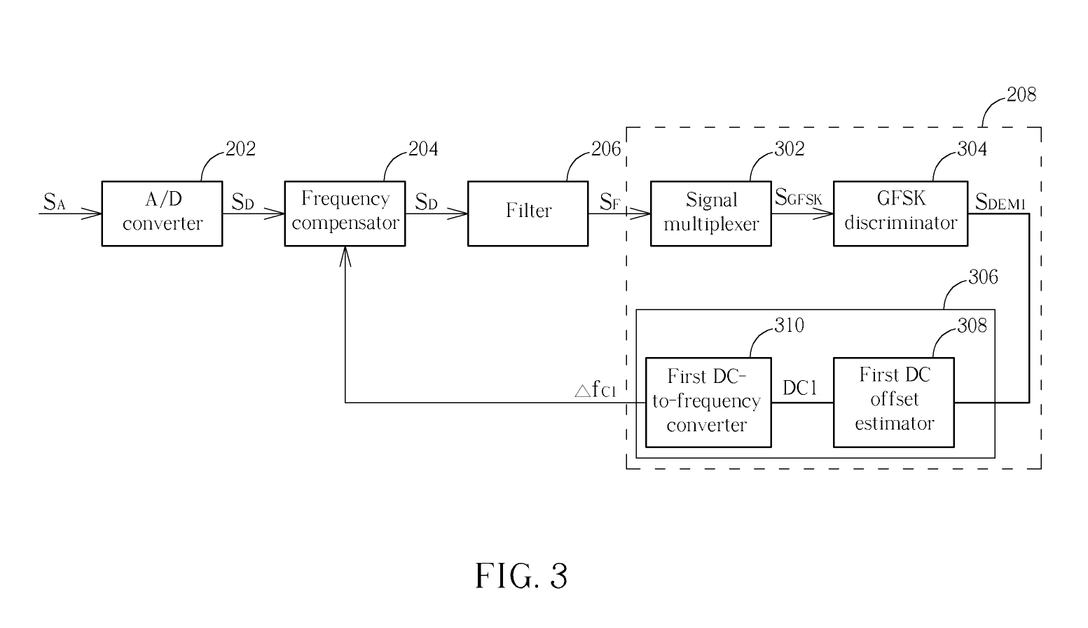

Furthermore, in a wireless communication system, such as a Bluetooth GFSK wireless communication system, the effect of carrier frequency offset at the received signal can be converted to a DC offset after demodulation. So, the carrier frequency offset value Δf_{C} can be estimated according to the above-mentioned property. Please refer to FIG. 3. FIG. 3 is a schematic diagram of the frequency offset estimator 208 shown in FIG. 2 according to an embodiment of the present invention. The frequency offset estimator 208 includes a signal multiplexer 302, a GFSK discriminator 304, and an initial frequency offset estimator 306. The signal multiplexer 302 is coupled to the filter 206 for selecting a Gaussian Frequency Shift Keying (GFSK) modulated signal S_{GFSK} from the output signal S_{F} according to the output signal S_{F}. Generally, the Bluetooth packets can be modulated with GFSK modulation or Differential Phase Shift Keying (DPSK) modulation, so that the signal multiplexer 302 chooses the corresponding GFSK modulated signal S_{GFSK} for the GFSK discriminator 304. After that, the GFSK discriminator 304 is coupled to the signal multiplexer 302 for demodulating the GFSK modulated signal S_{GFSK} to generate a first demodulated signal S_{DEM1}. The initial frequency offset estimator 306 is utilized for preliminarily estimating a first carrier frequency offset value Δf_{C1} of the first demodulated signal S_{DEM1}. In such a situation, the initial frequency offset estimator 306 includes a first DC offset estimator 308 and a first DC to frequency converter 310. The first DC offset estimator 308 is coupled to the GFSK discriminator 304 for estimating a first DC offset value DC1 according to the first demodulated signal S_{DEM1}. The first DC to frequency converter 310 is coupled to the first DC offset estimator 308 for converting the first DC offset value DC1 to the first carrier frequency offset value Δf_{C1}, and providing the first carrier frequency offset value Δf_{C1} to the frequency compensator 204 for implementing carrier recovery.

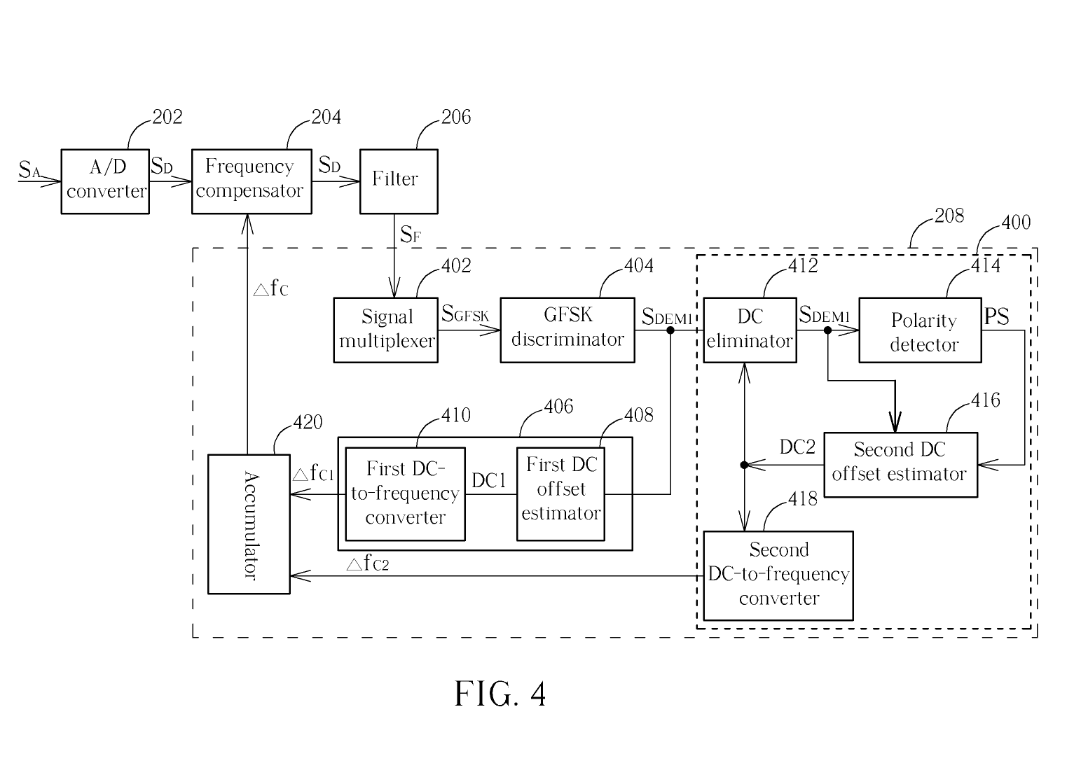

To avoid the inaccurate result of the first carrier frequency offset value Δf_{C1} estimated by the initial frequency offset estimator 306 and the frequency drift issue after compensation, the following further elaborates another embodiment of the frequency offset estimator 208. As shown in FIG. 4, the frequency offset estimator 208 includes a signal multiplexer 402, a GFSK discriminator 404, an initial frequency offset estimator 406, and a DC tracker 400. Please note that the units in the frequency offset estimator 208 shown in FIG. 4 with the same designations as those in the frequency offset estimator 208 shown in FIG. 3 have similar operations and functions, further description is omitted for brevity. The interconnections of the units are as shown in FIG. 4. The DC tracker 400 is utilized for estimating a second carrier frequency offset value Δf_{C2} of the first demodulated signal S_{DEM1}, which includes a DC eliminator 412, a polarity detector 414, a second DC offset estimator 416, and a second DC to frequency converter 418. After the initial frequency offset estimator 406 provides the first carrier frequency offset value Δf_{C1} to the frequency compensator 204 for compensating frequency of the digital signal S_{D}, the DC tracker 400 tracks the following remaining DC offset to modify carrier offset effect accurately. The DC eliminator 412 is coupled to the GFSK discriminator 404 for eliminating DC offset of the first demodulated signal S_{DEM1} according to a second DC offset value DC2. The polarity detector 414 is coupled to the DC eliminator 412 for detecting a polarity state PS of the first demodulated signal S_{DEM1}. The second DC offset estimator 416 is coupled to the polarity detector 414 for estimating the second DC offset value Δf_{C2} according to the polarity state PS to provide the second DC offset value Δf_{C2} to the DC eliminator 412 and the second DC to frequency converter 418. Moreover, the second DC to frequency converter 418 is coupled to the second DC offset estimator 416 for converting the second DC offset value DC2 to a second carrier frequency offset value Δf_{C2}. Note that, the second DC offset estimator 416 is able to provide the second DC offset value DC2 to the second DC to frequency converter 418 periodically. In addition, the frequency offset estimator 208 further includes an accumulator 420, which is coupled to the first DC to frequency converter 410 and the second DC to frequency converter 418 for accumulating the first carrier frequency offset value Δf_{C1} and the second carrier frequency offset value Δf_{C2} to generate the carrier frequency offset value Δf_{C}. Also, the accumulator 420 can provide the carrier frequency offset value Δf_{C} to the frequency compensator 204 for frequency compensation process.

In detail, please further refer to FIG. 4. Take Bluetooth communication technique as an example, the packet signal for Bluetooth communication technique usually includes three parts such as access code, header, and data part. As the packet signal is modulated with GFSK modulation, the initial frequency offset estimator 406 can calculate average DC offset value of a preamble symbol or a synchronization word of the access code for estimating the first DC offset value DC1. Also, the initial frequency offset estimator 406 can calculate average DC offset value of at least a portion of a preamble symbol or a synchronization word (such as the barker codes portion of the synchronization word) of the access code for estimating the first DC offset value DC1. Again, the DC tracker 400 estimates the second DC offset value DC2 according to the following symbols. In other words, the initial frequency offset estimator 406 calculates average DC offset value of a certain signal of the first demodulated signal S_{DEM1}, and transforms the calculated DC offset value to first carrier frequency offset value Δf_{C1}. The frequency compensator 204 uses the first carrier frequency offset value Δf_{C1} to compensate the following signal of the first demodulated signal S_{DEM1}. Furthermore, the DC tracker 400 estimates the second carrier frequency offset value Δf_{C2} from the compensated first demodulated signal S_{DEM1} to modify the frequency offset accurately. In addition, any kind of method that transforms the DC offset value into a corresponding frequency value could be used as the first DC to frequency converter 410 and the second DC to frequency converter 418. For instance, the first DC to frequency converter 410 or the second DC to frequency converter 418 can calculate the frequency offset value (such as ±160 KHz) according to the proportion of the DC offset value to the reference DC standard (such as ±1 volt) of symbol 0 and symbol 1. Otherwise, the first DC to frequency converter 410 and the second DC to frequency converter 418 can achieve the same purpose so that each of them can be share in the system design.

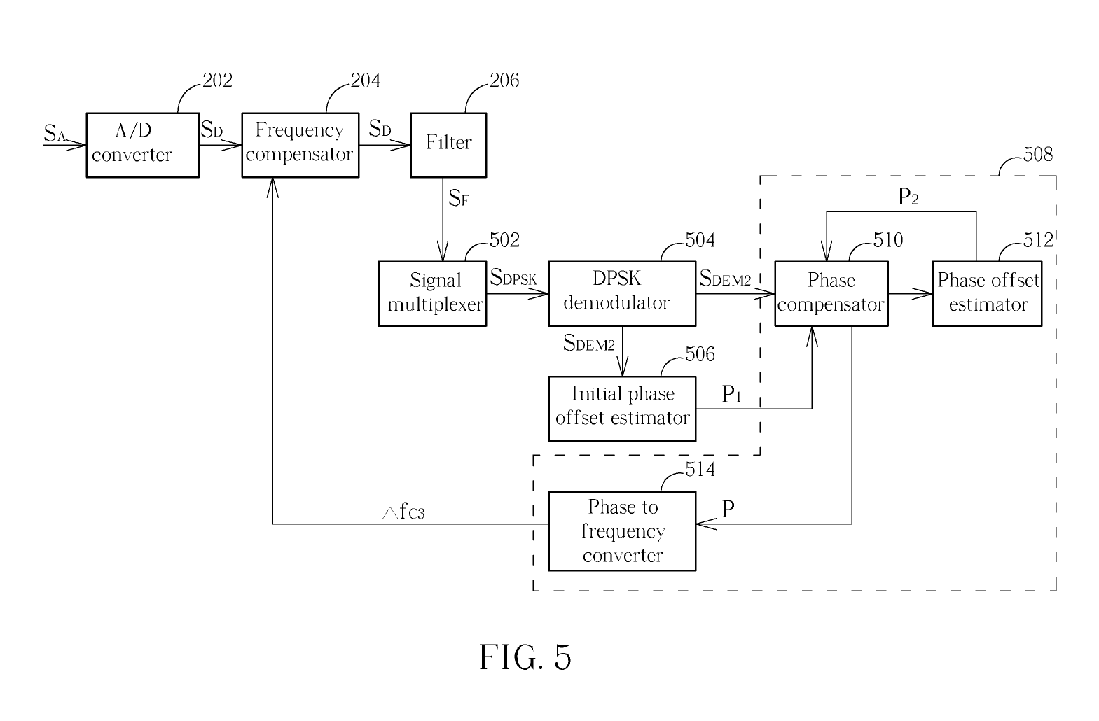

In version 2.0+ of the Bluetooth specification with Enhanced Data Rate (EDR), the data packet is modulated with DPSK modulation technique. For accelerating transmission speed, the transmitter will enable EDR mode, the GFSK modulated signal is first transmitted, and the DPSK modulated signal is transmitted immediately. Therefore, regarding the DPSK modulated signal, please refer to FIG. 5. FIG. 5 is a schematic diagram of the frequency offset estimator 208 shown in FIG. 2 according to another embodiment of the present invention. The effect of carrier frequency offset at the DPSK modulated signal can be converted to phase offset after demodulation. As shown in FIG. 5, the frequency offset estimator 208 includes a signal multiplexer 502, a DPSK demodulator 504, an initial phase offset estimator 506, and a phase tracker 508. The signal multiplexer 502 is coupled to filter 206 for selecting a DPSK modulated signal S_{DPSK} from the output signal S_{F}. The DPSK demodulator 504 is coupled to the signal multiplexer 502 for demodulating the DPSK modulated signal S_{DPSK} to generate a second demodulated signal S_{DEM2}. The initial phase offset estimator 506 is coupled to the DPSK demodulator 504 for estimating a first phase offset value P₁ of the second demodulated signal S_{DEM2}. Preferably, the initial phase offset estimator 506 can be realized with a correlator for calculating the first phase offset value P₁ according to the property that the correlator outputs a maximum value when a synchronization code of the second demodulated signal S_{DEM2} is at the same position. The phase tracker 508 is utilized for estimating a third carrier frequency offset value Δf_{C3} of the second demodulated signal S_{DEM2}, which includes a phase compensator 510, a phase offset estimator 512, and a phase to frequency converter 514. The phase compensator 510 is utilized for preliminary compensating phase of the second demodulated signal S_{DEM2}, and the phase offset estimator 512 feeds a second phase offset value P₂ of the compensated second demodulated signal S_{DEM2} to the phase compensator 510 successively to correct the phase offset progressively. The phase compensator 510 is coupled to the DPSK demodulator 504 and the initial phase offset estimator 506 for compensating phase of the second demodulated signal S_{DEM2} to generate the compensated second demodulated signal S_{DEM2} and generating a phase offset value P according to the first phase offset value P₁ and a second phase offset value P₂. Note that, the phase compensator 510 can add the first phase offset value P₁ and a second phase offset value P₂ to the phase offset value P periodically, and provide the phase offset value P to the phase to frequency converter 514. The phase offset estimator 512 is coupled to the phase compensator 510 for estimating the second phase offset value P₂ of the compensated second demodulated signal S_{DEM2}, and providing the second phase offset value P₂ to the phase compensator 510. The phase to frequency converter 514 is coupled to the phase compensator 510 for converting the phase offset value P to the third carrier frequency offset value Δf_{C3}, and providing the third carrier frequency offset value Δf_{C3} to the frequency compensator 204 for recovering correct carrier frequency.

Note that, the frequency offset estimator 208 shown in FIG. 2 is an exemplary embodiment of the present invention, and those skilled in the art can make alternations and modifications accordingly. For example, any other circuits and components which can realize functions of the carrier frequency offset estimator 208 is suitable. On the other hand, when the system takes the EDR mode, the present invention can combine the schemes shown in FIG. 4 and FIG. 5 and integrate various application components for implementing carrier recovery, and those skilled in the art can make alternations and modifications accordingly. For example, the signal multiplexer 302 and the signal multiplexer 502 can be integrated with a signal multiplexer. The phase to frequency converter 514 can be coupled to the accumulator 420 so that the accumulator 420 can perform the accumulation of the first carrier frequency offset value Δf_{C1}, the second carrier frequency offset value Δf_{C2}, and the third carrier frequency offset value Δf_{C3} to generate the carrier frequency offset value Δf_{C}. In addition, the demodulated signal often distributes over low frequency range, that is, the demodulated signal has less energy over the high frequency range, so that the filter 206 is preferably implemented by a low pass filter for filtering noise among the high frequency range. The frequency compensator 204 is capable of being realized by a Numerical Controlled Oscillator (NCO) to generate sine and cosine waveforms for modifying frequency offset according to the estimated frequency offset value.

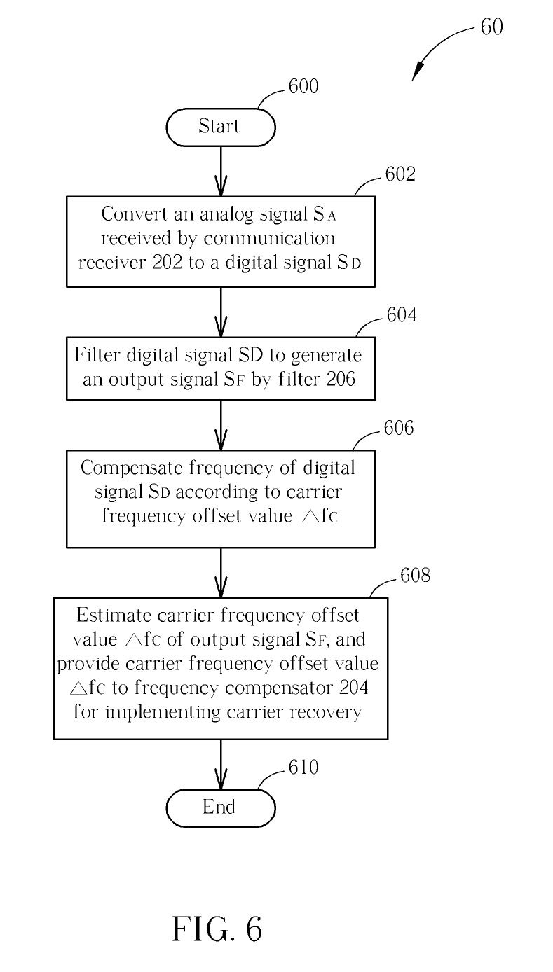

As to the implementation of the carrier recovery device 20, please refer to FIG. 6. FIG. 6 is a procedure 60 according to an embodiment of the invention. The procedure 60 is utilized for the carrier recovery device 20 of a Bluetooth receiver. The procedure 60 comprises the following steps:

Step 600: Start.

Step 602: Convert an analog signal S_{A} received by communication receiver 202 to a digital signal S_{D}.

Step 604: Filter digital signal S_{D} to generate an output signal S_{F} by filter 206.

Step 606: Compensate frequency of digital signal S_{D} according to carrier frequency offset value Δf_{C}.

Step 608: Estimate carrier frequency offset value Δf_{C} of output signal S_{F}, and provide carrier frequency offset value Δf_{C} to frequency compensator 204 for implementing carrier recovery.

Step 610: End.

Please note that the procedure 60 is utilized for illustrating the implementation of carrier recovery device 20, and the related variations and the detailed description can be referred to in the foregoing description, so as not to be narrated herein for the sake of brevity.

In summary, the embodiment of the present invention can estimate the carrier frequency offset value, and use tracking compensation method to modify frequency offset. As a result, the present can recover the most accurate carrier, keep the received signal away from destroying by the filter, improve signal distortion, and enhance system performance.

Those skilled in the art will readily observe that numerous modifications and alterations of the device and method may be made while retaining the teachings of the invention.

What is claimed is:

1. A carrier recovery device for a communication receiver, comprising:
an A/D converter for converting a received analog signal to a digital signal;
a frequency compensator coupled to the A/D converter for compensating a frequency of the digital signal according to a carrier frequency offset value;
a filter coupled to the frequency compensator for filtering the digital signal to generate an output signal; and
a frequency offset estimator coupled to the filter and the frequency compensator for estimating the carrier frequency offset value according to the output signal and providing the carrier frequency offset value to the frequency compensator for implementing carrier recovery.

2. The carrier recovery device of claim 1, wherein the frequency offset estimator comprises:
a signal multiplexer coupled to the filter for selecting a Gaussian Frequency Shift Keying (GFSK) modulated signal from the output signal according to the output signal;
a GFSK discriminator coupled to the signal multiplexer for demodulating the GFSK modulated signal to generate a first demodulated signal; and
an initial frequency offset estimator for preliminarily estimating a first carrier frequency offset value of the first demodulated signal, comprising:
a first DC offset estimator coupled to the GFSK discriminator for estimating a first DC offset value according to the first demodulated signal; and
a first DC to frequency converter coupled to the first DC offset estimator for converting the first DC offset value to the first carrier frequency offset value.

3. The carrier recovery device of claim 2, wherein the DC to frequency converter provides the first carrier frequency offset value to the frequency compensator for implementing carrier recovery.

4. The carrier recovery device of claim 2, wherein the frequency offset estimator further comprises:
a DC eliminator coupled to the GFSK discriminator for eliminating DC offset of the first demodulated signal according to a second DC offset value;
a polarity detector coupled to the DC eliminator for detecting a polarity state of the first demodulated signal;
a second DC offset estimator coupled to the polarity detector for estimating the second DC offset value according to the polarity state to provide the second DC offset value to the DC eliminator; and
a second DC to frequency converter coupled to the second DC offset estimator for converting the second DC offset value to a second carrier frequency offset value.

5. The carrier recovery device of claim 4, wherein the frequency offset estimator further comprises:
an accumulator coupled to the first DC to frequency converter and the second DC to frequency converter for accumulating the first carrier frequency offset value and the second carrier frequency offset value to generate the carrier frequency offset value, and providing the carrier frequency offset value to the frequency compensator.

6. The carrier recovery device of claim 2, wherein the initial frequency offset estimator calculates average DC offset value of a preamble symbol or a synchronization word according to the preamble symbol or the synchronization word of the first demodulated signal for estimating the first DC offset value.

7. The carrier recovery device of claim 2, wherein the initial frequency offset estimator calculates average DC offset value of at least a portion of a preamble symbol or a synchronization word according to the preamble symbol or the synchronization of the first demodulated signal for estimating the first DC offset value.

8. The carrier recovery device of claim 1, wherein the frequency offset estimator comprises:
a signal multiplexer coupled to the filter for selecting a Differential Phase Shift Keying (DPSK) modulated signal from the output signal according to the output signal;
a DPSK demodulator coupled to the signal multiplexer for demodulating the DPSK modulated signal to generate a second demodulated signal;
an initial phase offset estimator coupled to the DPSK demodulator for estimating a first phase offset value of the second demodulated signal according to the second demodulated signal; and
a phase tracker, comprising:
a phase compensator coupled to the DPSK demodulator and initial phase offset estimator for compensating phase of the second demodulated signal to generate the compensated second demodulated signal and generating a phase offset value according to the first phase offset value and a second phase offset value;
a phase offset estimator coupled to the phase compensator for estimating the second phase offset value of the compensated second demodulated signal, and providing the second phase offset value to the phase compensator; and
a phase to frequency converter coupled to the phase compensator for converting the phase offset value to the third carrier frequency offset value, and providing the third carrier frequency offset value to the frequency compensator.

9. The carrier recovery device of claim 8, wherein the initial phase offset estimator is a correlator for calculating the first phase offset value according to correlation of the a synchronization code of the second demodulated signal by different time.

10. The carrier recovery device of claim 1, wherein the frequency compensator is a numerical controlled oscillator.

11. The carrier recovery device of claim 1, wherein the filter is a low pass filter.

12. A carrier recovery method, comprising:
converting a received analog signal to a digital signal;
filtering the digital signal to generate an output signal;
estimating a carrier frequency offset value of the output signal; and
compensating frequency of the digital signal according to the carrier frequency offset value for implementing carrier recovery.

13. The carrier recovery method of claim 12, wherein the step of estimating the carrier frequency offset value of the output signal comprises:
selecting a Gaussian Frequency Shift Keying (GFSK) modulated signal from the output signal according to the output signal;
demodulating the GFSK modulated signal to generate a first demodulated signal;
estimating a first DC offset value according to the first demodulated signal; and
converting the first DC offset value to a first carrier frequency offset value.

14. The carrier recovery method of claim 13, wherein the step of compensating frequency of the digital signal according to the carrier frequency offset value for implementing carrier recovery comprises:
compensating frequency of the digital signal according to the first carrier frequency offset value for implementing carrier recovery.

15. The carrier recovery method of claim 12, wherein the step of estimating the carrier frequency offset value of the output signal comprises:
detecting a polarity state of the first demodulated signal;
estimating a second DC offset value according to the polarity state of the first demodulated signal;
eliminating DC offset of the first demodulated signal according to the second DC offset value; and
converting the second DC offset value to a second carrier frequency offset value.

16. The carrier recovery method of claim 15, wherein the step of converting the second DC offset value to a second carrier frequency offset value comprises:
accumulating the first carrier frequency offset value and the second carrier frequency offset value to generate the carrier frequency offset value for frequency compensation.

17. The carrier recovery method of claim 13, wherein the step of estimating the first DC offset value according to the first demodulated signal comprises:
calculating average DC offset value of a preamble symbol or a synchronization word according to the preamble symbol or the synchronization word of the first demodulated signal for estimating the first DC offset value.

18. The carrier recovery method of claim 13, wherein the step of estimating the first DC offset value according to the first demodulated signal comprises:
calculating average DC offset value of at least a portion of a preamble symbol or a synchronization word according to the preamble symbol or the synchronization word of the first demodulated signal for estimating the first DC offset value.

19. The carrier recovery method of claim 13, wherein the step of estimating the carrier frequency offset value of the output signal comprises:
selecting a Differential Phase Shift Keying (DPSK) modulated signal from the output signal according to the output signal;
demodulating the DPSK modulated signal to generate a second demodulated signal;
estimating a first phase offset value of the second demodulated signal according to the second demodulated signal;
compensating phase of the second demodulated signal according to the first phase offset value and a second phase offset value to generate the compensated second demodulated signal;
estimating the second phase offset value according to the compensated second demodulated signal;
generating a phase offset value according to the first phase offset value and the second phase offset value; and
converting the phase offset value to a third carrier frequency offset value.

20. The carrier recovery method of claim 19, wherein the step of estimating the first phase offset value of the second demodulated signal according to the second demodulated signal comprises:
calculating the first phase offset value according to correlation of the synchronization code of the second demodulated signal by different time.
